(19) United States
(12) Patent Application Publication
(10) Pub. No.: US 2020/0088469 A1
(43) Pub. Date: Mar. 19, 2020

(54) FOAMING HEATING SYSTEM

(71) Applicant: MEGA MASTER TECHNOLOGY CO., LTD., New Taipei City (TW)

(72) Inventors: Fang-Juei CHOU, New Taipei City (TW); Li-Chun YU, New Taipei City (TW); Chun-Yung YU, New Taipei City (TW); Han-Hsing HSIUNG, New Taipei City (TW)

(73) Assignee: MEGA MASTER TECHNOLOGY CO., LTD., New Taipei City (TW)

(21) Appl. No.: 16/572,274

(22) Filed: Sep. 16, 2019

(30) Foreign Application Priority Data
Sep. 14, 2018 (TW) 107132505
Sep. 16, 2019 (TW) 108133257

(51) Int. Cl. F27B 9/40; F27B 9/00; F27B 9/30

(52) U.S. Cl. CPC F27B 9/40; F27D 21/0014; F27B 9/3005; F27B 9/00

(57) ABSTRACT

A foaming heating system includes a furnace, a conveying device, a heating device and a plurality of detectors. The furnace has a furnace body, a heating channel and ventilation holes. The conveying device transports foam material passing through the heating channel. The heating device has a heater, a heating tube, a temperature regulator and at least one temperature adjustment pipeline. The plurality of detectors detects the temperature of each section of the heating channel. When a temperature abnormality of a certain section is detected, the temperature of the certain section is adjusted by the at least one temperature adjustment pipeline.

### CROSS REFERENCE TO RELATED APPLICATION

This application claims the priority benefit of Taiwanese Patent Application Serial Number 107132505, filed on Sep. 14, 2018, and Taiwanese Patent Application Serial Number 108133257 filed on Sep. 16, 2019, the full disclosure of which is incorporated herein by reference.

### BACKGROUND

### Technical Field

The present invention relates to a heating system, and more particularly to a heating foaming system for heating a foamed material.

### Related Art

A foaming material is made from a base material having a plurality of tiny pores formed therein by using a suitable foaming agent and a catalyst. The base material is selected from different polymer. There are various kinds of foaming material. It can be classified according to the expansion ratio, softness and foaming structure for different industrial products application.

In the conventional electron beam irradiation technology, in the foaming process, the foaming raw material obtained by kneading needs to be first pressed and cut into a fragment foaming board, and then the fragment foaming board is processed under cross-linked reaction. The fragment foaming board not only limits the application area of the end product due to the fixed length, but also reduces the efficiency of the subsequent foaming process. The continuous foaming process by way of conveying the guide tape through the foaming furnace usually causes the problem of uneven heating on the roll-typed foaming material and foaming due to the excessively long furnace body. Accordingly, the present disclosure is directed to an improvement over the above disadvantages and provides a foaming hearing system.

### SUMMARY

The present disclosure provides a foaming hearing system such that the roll-typed foaming material can be uniformly heated to provide a foaming material with a better foaming effect.

In one embodiment, the foaming hearing system comprises a furnace, a conveying device, a heating device and a plurality of detectors. The furnace has a furnace body, a heating channel formed inside the furnace body and a plurality of ventilation holes formed on the furnace body. The heating channel divided into at least one section. the plurality of the ventilation holes respectively communicating with at least one section of the heating channel. The conveying device transports foaming material passing through the heating channel. The heating device having a heater, a heating tube, a temperature regulator and at least one temperature adjustment pipeline. The heater connects to the temperature regulator. The at least one temperature adjustment pipeline respectively communicates with the plurality of ventilation holes. The plurality of detectors is respectively arranged in the heating channel. The plurality of detectors corresponds to the plurality of ventilation holes. The plurality of detectors electrically is connected to the temperature regulator. The plurality of detectors detects the temperature of the at least one section of the heating channel. The temperature regulator respectively adjusts the temperature of the at least one section of the heating channel through the temperature adjustment pipelines.

In another embodiment, the furnace is a horizontal furnace, a vertical furnace or a horizontal furnace combined with a vertical furnace.

In another embodiment, the plurality of the ventilation holes is arranged on at least one section of the furnace body with equal space or non-equal space.

In another embodiment, the plurality of the ventilation holes is arranged to surround on at least one section of the furnace body.

In another embodiment, the plurality of detectors is arranged on at least one section of the heating channel with equal space or non-equal space.

In another embodiment, the plurality of detectors is arranged to surround on at least one section of the furnace body.

In another embodiment, an inlet and an outlet are respectively formed at two ends of the heating channel, the temperature regulator controls the temperature in the heating channel to gradually decrease from the inlet to the outlet.

In another embodiment, a heat recycling channel is further arranged having one end connecting to the outlet of the hearing channel and the other end connecting to the heater of the heating device.

In another embodiment, the heating tube connects to the inlet of the hearting channel.

In another embodiment, the foaming material is rolled foaming base material

### BRIEF DESCRIPTION OF THE DRAWINGS

Other features, purposes and advantages of the present disclosure will become more apparent from the detailed description of non-restrictive embodiments taken in conjunction with the following drawings.

FIG. 1 is the schematic diagram of the forming heating system according to the first embodiment of the present disclosure;

FIG. 2 is the schematic diagram of the forming heating system according to the second embodiment of the present disclosure;

FIG. 3 is the schematic diagram of the forming heating system according to the third embodiment of the present disclosure;

FIG. 4 is the schematic diagram of the forming heating system according to the fourth embodiment of the present disclosure;

FIG. 5 is the schematic diagram of the forming heating system according to the fifth embodiment of the present disclosure; and

FIG. 6 is the schematic diagram of the forming heating system according to the sixth embodiment of the present disclosure.

### DESCRIPTION OF THE EMBODIMENTS

The technical scheme of the present disclosure is described below in further detail in conjunction with the drawings. It should be noted that the embodiments in the present disclosure and the characteristics of the embodiments may be arbitrarily combined if there is no conflict.

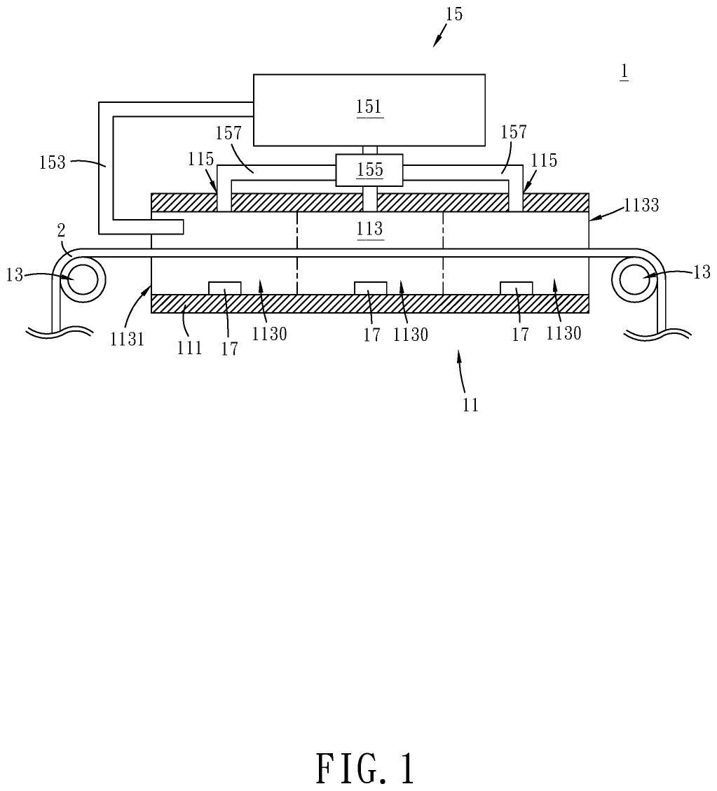

Refer to FIG. 1, showing the schematic diagram of the forming heating system according to the first embodiment of the present disclosure. The present disclosure provides a forming heating system for continuously heating rolled foaming material such that the rolled foaming material may be hearted uniformly with better forming effects. In this embodiment, the forming heating system 1 includes a furnace 11, a conveying device 13, a heating device 15 and a plurality of detectors 17.

In the embodiment, the furnace for hearing the foaming material is a horizontal furnace, a vertical furnace or a horizontal furnace combined with a vertical furnace. The furnace of this embodiment is illustrated using the horizontal furnace as an example. The furnace 11 includes a furnace body 111, a heating channel 113 and a plurality of ventilation holes 115. The heating channel 113 passes through the furnace body 111. An inlet 1131 and an outlet 1133 are respectively formed at two ends of the heating channel 113. The heating channel 113 is divided into at least one section 1130. The plurality of the ventilation holes 115 penetrates the furnace body 111 and respectively communicates with the heating channel 113. The ventilation holes 115 respectively correspond to the at least one section 1130. The conveying device 13 transports the rolled foaming material 2. The transportation route of the conveying device 13 transporting the foaming material 2 passes through the heating channel 113. The foaming material 2 is rolled foaming base material.

In the embodiment, the at least one section 1130 includes a plurality of section 3 1130. The partitioning manner of the sections 1130 may be equal or non-equal spacing. The plurality of the ventilation holes 115 may also be disposed in the at least one section 1130 of the furnace body 111 in an equally spaced or non-equal spacing manner. The partitioning manner of the section 1130 or the arrangement of the ventilation holes 115 in this embodiment can be adjusted and changed according to the needs of the user, and is not limited by this embodiment.

Further, the heating device 15 includes a heater 151, a heating tube 153, a temperature regulator 155 and at least one temperature adjustment pipeline 157. Although this embodiment is provided with the heating tube 153, the heating tube 153 may be optionally remove, or may be used as a recycling tube for recycling heat. The heater 151 is used to generate heat. the heater 151 connects and provides the heat to the heating tube 153 and the temperature regulator 155 respectively. The heating tube 153 communicates with the heating channel 113. The at least one temperature adjustment pipeline 157 respectively communicates with the ventilation holes 115. The number of the temperature adjustment pipelines and the number of the ventilation holes are corresponding with each other. The detectors 17 are electrically connected to the temperature adjuster 155. In the embodiment without the heating tube 153, the heater 151 provides heat to the temperature regulator 155.

In this embodiment, the foaming heating system 1 first generates hot air by the heater 151 of the heating device 15. The heating channel 113 is heated to a predetermined temperature by the hot air. The conveying device 13 transports the rolled foaming material 2. The rolled foaming material 2 is transported into the heating channel 113 from the inlet 1131 and then is heated for foaming in the heating channel 113. In this embodiment, in order to maintain the foaming material 2 with a good heating foaming effect, the heating channel 113 is divided into a plurality of sections 1130. This embodiment divides the heating channel 113 into a front section, a middle section and a rear section. For facilitating subsequent explanation, the front section is close to the inlet 1131, and the rear section is close to the outlet 1133. However, this embodiment does not limit the number of sections. The plurality of detectors 17 are arranged corresponding to the front section, the middle section and the rear section of the heating channels 113. The detector 17 detects whether the temperature in each section reaches a preset temperature for heating and foaming.

If the detector 17 detects that the temperature of the rear section of the heating channel 113 is lower than the preset heating foaming temperature, the corresponding signal is sent to the temperature adjuster 155 of the heating device 15 through the detector 17. The temperature adjuster 155 controls the temperature adjustment pipeline 157 of the corresponding rear section for heating. The hot air enters the heating channel 113 through the ventilation holes 115 corresponding to the rear section by the temperature adjustment pipeline 157. When the detector 17 detects that the temperature of the rear section of the heating channel 113 has reached the preset temperature for heating and foaming, the temperature adjuster 155 receives the signal of the detector 17 again, and the temperature adjustment pipeline 157 stops heating.

As described above, the temperature adjustment operation of the front section, the middle section and the rear section of the heating passage 113 are the same, and therefore will not be described again. The temperature adjuster 155 performs temperature control of each section on the temperature of the heating channel 113 through the detector 17 of each section. The temperature adjuster 155 performs temperature control for the temperature of each section of the heating channel 113 through the detectors 17 arranged in each section such that the temperature for heating and foaming of each section is maintained at the preset temperature. This facilitates the user to master the expected degree of foaming after the foaming material 2 is heated and foamed. Furthermore, the temperature of the heating channel 113 f is from high to low from the front section to the rear section. That is, the temperature in the heating channel 113 gradually decreases from the inlet 1131 to the outlet 1133 in order to allow the foaming material 2 to slowly cure. Most of the temperature control methods for each of the sections 1130 by for the temperature adjuster 155 are the same as the temperature configuration described above. The temperature adjuster 155 controls the temperature of the front section to the temperature of the rear section (i.e., the direction from the inlet 1131 to the outlet 1133) from high to low. However, this embodiment does not limit the temperature control mode of from high temperature to low temperature, and the temperature control can be adjusted according to user requirements.

This embodiment improves the disadvantages of the prior art. In the process of heating the rolled foaming material in the prior art, due to the foaming material being of a strip type, it is easy to make the foaming effect of the foaming material worse under uneven heating. Therefore, the embodiment provides a foaming heating system 1. The rolled foaming material 2 is transported by the axles for heating. Because the rolled foaming material 2 passes through the elongated heating channel 113, in order to maintain a good heating foaming effect under the temperature in the heating channel 113, the heating channel 113 is divided into a plurality of sections 1130. Each section 1130 has a corresponding detector 17 and temperature adjustment pipeline 157. If the detector 17 of the section 1130 detects that the temperature is lower than the preset temperature, the temperature adjustment pipeline 157 automatically heats and adjusts the temperature of the section 1130 to the preset temperature. The detector 17 monitors the temperature in the heating channel 113 at any time to maintain an optimum heating temperature for foaming in the heating channel 113 such that the rolled foaming material can achieve the optimum foaming effect.

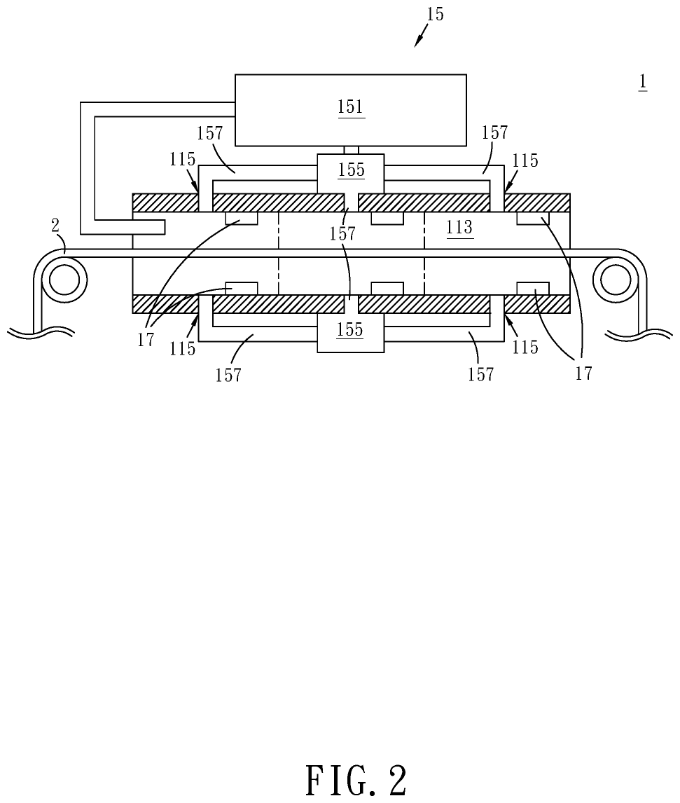

Refer to FIG. 2, showing the schematic diagram of the forming heating system according to the second embodiment of the present disclosure. As shown in the figure, the difference between this embodiment and the first embodiment lies in the arrangement of the at least one temperature adjustment pipeline 157. In the embodiment, the plurality of the ventilation holes 115 are disposed on the furnace body 111 in an equally spaced manner, and the ventilation holes 115 are further disposed around the same section of the furnace body 111. In other words, the temperature adjustment pipelines 157 also connect to the corresponding ventilation holes 115 on the other side of the furnace body 111. When the temperature adjustment pipelines 157 is required to heat one section of the heating channel 113, the temperature adjustment pipeline 157 is capable of heating the heating passage 113 evenly, so that the heating channel 113 can quickly reach a preset temperature.

Furthermore, the detector 17 can be further disposed to surround at least one section of the heating channel 113. The plurality of detectors 17 can more accurately measure the temperature of the same section in the heating channel 113, ensuring that the heating temperatures of the sections in the heating channel 113 can be maintained at their respective preset temperatures. Therefore, the temperature of heating for foaming in each section of the foaming material 2 is controlled more accurately, so that the foaming effect of the foaming material 2 is better.

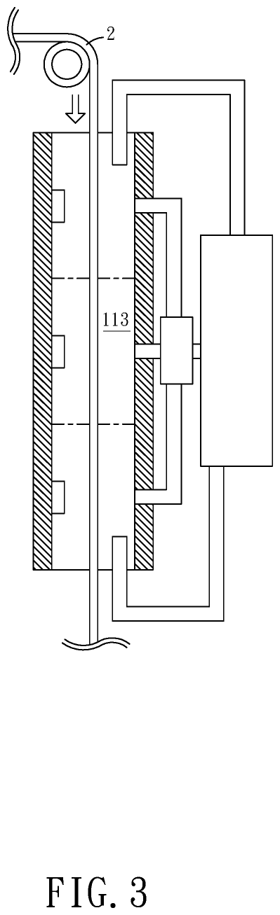

Refer to FIG. 3, showing the schematic diagram of the forming heating system according to the third embodiment of the present disclosure. As shown in the figure, the difference between this embodiment and the first embodiment lies in the application of the vertical furnace and the horizontal furnace. In the vertical furnace of this embodiment, except that the heating channel 113 of the foaming heating system 1 is placed vertically to the ground for heating, and the foaming material suitable for the vertical furnace is adopted, the rest of the structure and the arrangement are the same as those of the first embodiment, and therefore will not be described again.

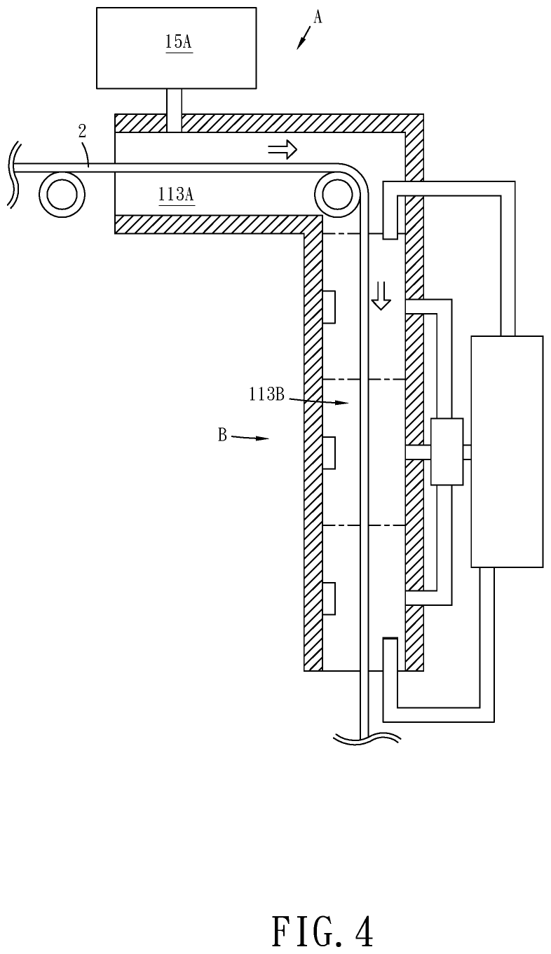

Refer to FIG. 4, showing the schematic diagram of the forming heating system according to the fourth embodiment of the present disclosure. As shown in the figure, the difference between this embodiment and the third embodiment is that this embodiment further includes the combination and application of the horizontal furnace. In this embodiment, the outlet of the horizontal furnace A is combined with the inlet of the vertical furnace B. The horizontal furnace A of the present embodiment is a simplified as shown in the first embodiment. The horizontal furnace A has a heating device 15A and a heating channel 113A, and the heating device 15A can heat the heating channel 113A.

In this embodiment, the temperature of the heating channel 113A in the horizontal furnace A is lower than the temperature of the heating channel 113B in the vertical furnace B. The foaming material 2 is first preheated in the horizontal furnace A such to raise the temperature of the entire foaming material 2. Then the foaming material 2 is further transported to the heating channel 113B of the vertical furnace B for hearting and forming. By way of such matter the foaming material 2 can obtain an optimum foaming effect both inside and outside.

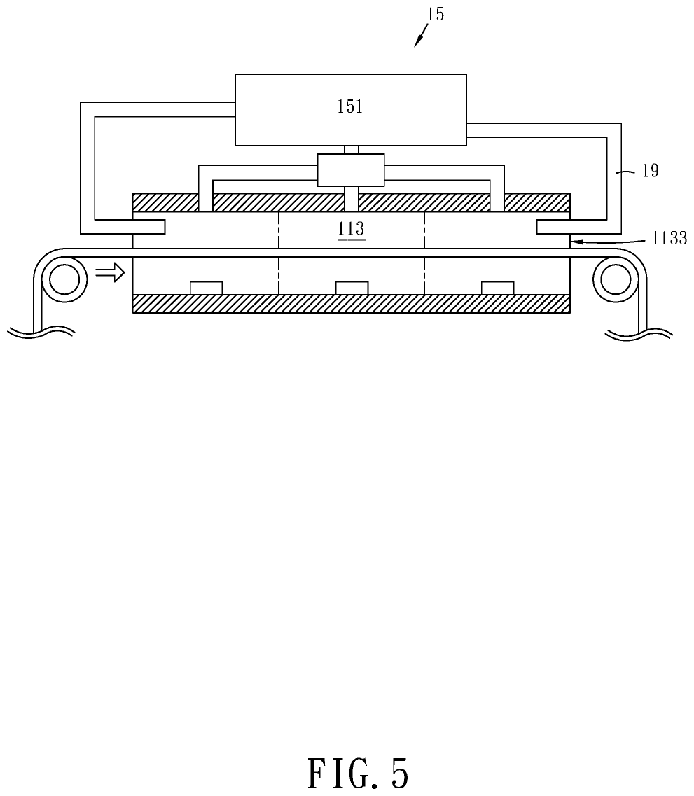

Refer to FIG. 5, showing the schematic diagram of the forming heating system according to the fifth embodiment of the present disclosure. As shown in the figure, the difference between this embodiment and the first embodiment is that this embodiment further includes a heat recycling channel 19. In this embodiment, one end of the heat recycling channel 19 communicates with the outlet 1133 of the heating channel 113, and the other end thereof communicates with the heater 151 of the heating device 15. The heat recycling channel 19 receives the hot air discharged from the outlet 1133 of the heating passage 113. Although the residual temperature of the hot air is lower than the preset temperature for heating and foaming, it is still higher than the general ambient temperature. This can save the energy for heating from the general ambient temperature to the residual temperature. In other words, based on the residual temperature and continuing to heat to the preset temperature for heating and foaming, the energy saving effect can be effectively achieved.

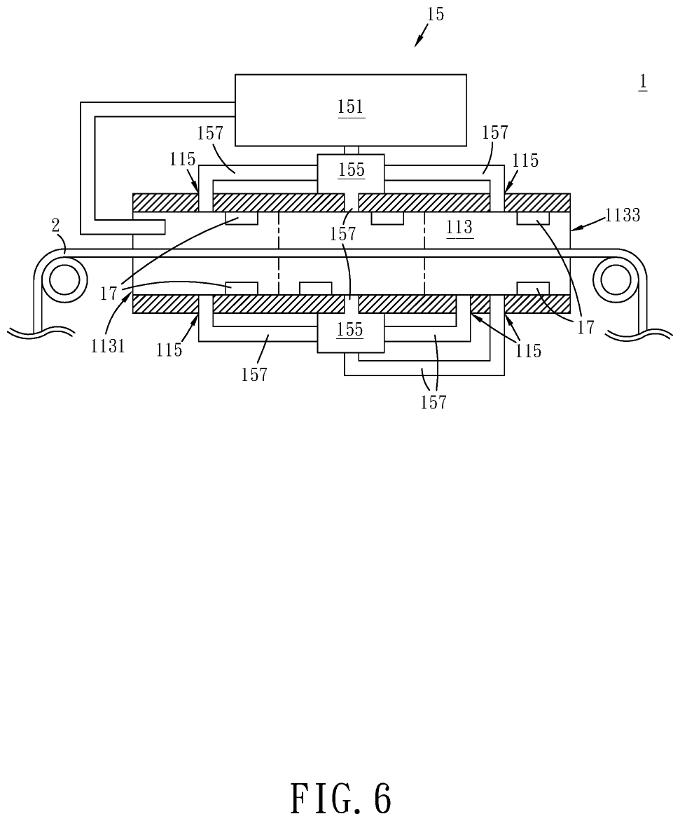

Refer to FIG. 6, showing the schematic diagram of the forming heating system according to the sixth embodiment of the present disclosure. As shown in the figure, the difference between this embodiment and the second embodiment lies in the arrangement of the at least one temperature adjustment pipeline 157 and the arrangement of the detectors 17. In this embodiment, the at least one temperature adjustment pipeline 157 need to communicate with the furnace body 111 through the ventilation holes 115. The plurality of ventilation holes 115 can be disposed on the furnace body 111 according to the needs of the user. The plurality of ventilation holes 115 may be disposed on at least one section of the furnace body 111 at equal intervals or non-equal intervals, or may be disposed around the furnace body 111. The manner in which the plurality of ventilation holes 115 are disposed around the furnace body 111 may be symmetrically arranged or asymmetrically arranged. As shown in FIG. 6, the ventilation holes 115 are disposed in such a manner that a single ventilation hole 115 is provided on one side of the furnace body 111, and two ventilation holes 115 are provided on the other side the furnace body 111. The arrangement of the ventilation holes 115 can be adjusted according to the needs of the user, and is not limited to the embodiment.

In addition, the manner in which the detector 17 is disposed may be the same as the manner in which the plurality of ventilation holes 115 are disposed, and therefore the explanation will not be described again. As shown in FIG. 6, a detector 17 is disposed on the inner side of the section 1130 of the heating channel 113 near the outlet 1133, and another detector 17 is disposed on the inner side of the section 1130 of the heating channel 113 near the inlet 1133. The manner in which the detector 17 is disposed can be adjusted according to user requirements, and is not limited to the embodiment.

In summary, the present disclosure provides a foaming heating system, which comprises a furnace, a conveying device, a heating device and a plurality of detectors. The furnace has a heating channel. The conveying device transports the rolled foaming material through the long heating channel. The heating channel is divided into a plurality of sections, and each section has a corresponding detector and heating device. When the detector of the section detects that the temperature in the heating channel does not reach the preset temperature, the heating device automatically heats the heating channel to adjust the temperature of the section to the preset temperature. The detector monitors the temperature in the heating channel at any time to maintain an optimal heating foaming temperature in the heating channel, such that the rolled foaming material can achieve the best foaming effect.

The above are merely the embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A foaming heating system, comprising:
a furnace having a furnace body, a heating channel formed inside the furnace body and a plurality of ventilation holes formed on the furnace body, the heating channel divided into at least one section, the plurality of the ventilation holes respectively communicating with at least one section of the heating channel;
a conveying device transporting foaming material passing through the heating channel;
a heating device having a heater, a heating tube, a temperature regulator and at least one temperature adjustment pipeline; the heater connecting to the temperature regulator; the at least one temperature adjustment pipeline respectively communicating with the plurality of ventilation holes; and
a plurality of detectors respectively arranged in the heating tube, the plurality of detectors corresponding to the plurality of ventilation holes, the plurality of detectors electrically connected to the temperature regulator;
wherein the heating tube heats the heating channel, the plurality of detectors detects the temperature of the at least one section of the heating channel, the temperature regulator respectively adjusts the temperature of the at least one section of the heating channel through the temperature adjustment pipelines.

2. The foaming heating system of claim 1, wherein is the furnace is a horizontal furnace, a vertical furnace or a horizontal furnace combined with a vertical furnace.

3. The foaming heating system of claim 1, wherein the plurality of the ventilation holes is arranged on at least one section of the furnace body with equal space or non-equal space.

4. The foaming heating system of claim 1, wherein the plurality of the ventilation holes is arranged to surround on at least one section of the furnace body.

5. The foaming heating system of claim 1, wherein the plurality of detectors is arranged on at least one section of the heating channel with equal space or non-equal space.

6. The foaming heating system of claim 1, wherein the plurality of detectors is arranged to surround on at least one section of the furnace body.

7. The foaming heating system of claim 1, wherein an inlet and an outlet are respectively formed at two ends of the heating channel, the temperature regulator controls the temperature in the heating channel to gradually decrease from the inlet to the outlet.

8. The foaming heating system of claim 7, further comprising a heat recycling channel, with one end connecting to the outlet of the hearing channel and the other end connecting to the heater of the heating device.

9. The foaming heating system of claim 7, wherein the heating tube connects to the inlet of the hearting channel.

10. The foaming heating system of claim 7, wherein the foaming material is rolled foaming base material.
